(19) United States
(12) Patent Application Publication
(10) Pub. No.: US 2013/0176400 A1
(43) Pub. Date: Jul. 11, 2013

(54) APPARATUS AND METHOD OF AUTOMATICALLY CORRECTING BRIGHTNESS OF IMAGES CAPTURED BY MULTIPLE CAMERAS

(71) Applicants: In Su JANG, Daegu (KR); Jin Seo Kim, Daejeon (KR); Soon Young Kwon, Yangsan-si (KR); Song Woo Lee, Daejeon (KR); Ju Yeon You, Daegu (KR); Maeng Sub Cho, Daejeon (KR)

(72) Inventors: In Su JANG, Daegu (KR); Jin Seo Kim, Daejeon (KR); Soon Young Kwon, Yangsan-si (KR); Song Woo Lee, Daejeon (KR); Ju Yeon You, Daegu (KR); Maeng Sub Cho, Daejeon (KR)

(73) Assignee: Electronics and Telecommunications Research Institute, Daejeon (KR)

(21) Appl. No.: 13/601,907

(22) Filed: Aug. 31, 2012

(30) Foreign Application Priority Data
Jan. 5, 2012 (KR) 10-2012-0001506

(51) Int. Cl. G06T 5/00; H04N 13/02

(52) U.S. Cl. 348/47; 382/154; 348/E13.074

(57) ABSTRACT

Disclosed is a technique for acquiring many images in different positions using multiple cameras to three dimensionally restore an object. The technique acquires images obtained by capturing an object by multiple cameras and corrects brightnesses between images captured by the multiple cameras based on an average brightness value calculated from the images captured by the multiple cameras so as to be constantly maintained. Therefore, it is possible to precisely restore a 3D model using images captured by multiple cameras having corrected brightness.

### CROSS-REFERENCE TO RELATED APPLICATIONS

This application claims priority to and the benefit of Korean Patent Application No. 10-2012-0001506 filed in the Korean Intellectual Property Office on Jan. 5, 2012, the entire contents of which are incorporated herein by reference.

### TECHNICAL FIELD

The present invention relates to an apparatus and a method of automatically correcting brightness for individual images captured by multiple cameras and brightness for individual positions of the images and more specifically, to an apparatus and a method of automatically correcting a brightness that is capable of precisely restoring a 3D image while maintaining uniform brightness between images captured by multiple cameras.

### BACKGROUND

As a technique for three-dimensionally restoring an object, there is a method that acquires lots of images in different locations using multiple cameras.

In order to precisely restore a 3D physical appearance using multiple cameras, it is most important to maintain consistency (for example, geometrical consistency and color consistency) between images captured by the cameras.

In order to maintain the geometrical consistency, correction is performed using a geometric calibration method of a camera to achieve an intended purpose. However, in this case, there is difficulty in restoring a precise 3D model due to inconsistency of the color and the brightness.

In other words, images captured by the cameras have different colors and different brightness. The brightness in an image captured by one camera is not uniform due to the position and the brightness of the illumination.

### SUMMARY

The present invention has been made in an effort to provide an apparatus and a method of correcting a brightness that allows precise 3D restoration by maintaining a brightness between images captured by multiple cameras to be constant and solving problems in that brightness distribution is not uniform due to the position in an image captured by one camera.

The present invention also provides a brightness correcting target that solves problems in that when an object is captured by multiple cameras in a studio environment, an object is not uniformly illuminated due to a fixed illumination condition and an intensity of illumination is varied depending on the position, which causes irregular brightness value of the captured image.

An exemplary embodiment of the present invention provides an automatic brightness correcting device, including: an image acquiring unit configured to acquire images obtained by capturing an object with multiple cameras; and an image correcting unit configured to correct brightnesses between images captured by the multiple cameras based on an average brightness value calculated from the images captured by the multiple cameras so as to be constantly maintained.

The image acquiring unit may include: a communicating unit configured to communicate with the multiple cameras to receive the images captured by the multiple cameras; and a storing unit configured to store the received image so as to be mapped with the cameras that capture the images.

The image correcting unit may include: a brightness calculating unit configured to calculate an average value, a maximum value, and a minimum value of the brightness values of the images captured by the multiple cameras and calculate the average brightness value of the total images from the calculated average value; a correction field selecting unit configured to select a field where the brightness values of the images are corrected based on the average value, the maximum value, and the minimum value of the brightness values of the images captured by the multiple cameras; and an image converting unit configured to generate the correction function for correcting the brightness value of the images based on the average brightness value and the field to be corrected and convert the image using the generated correction function.

Another exemplary embodiment of the present invention provides an automatic brightness correcting device, including: a brightness correcting target configured to be cylindrical and to have a size determined by considering a size of an object to be three-dimensionally restored; multiple cameras that are disposed in predetermined positions with respect to a brightness correcting target and capture the brightness correcting target; and an image processing device configured to correct the brightnesses between the images captured by the multiple cameras based on the average brightness value calculated from the images captured by the multiple cameras so as to be constantly maintained.

Yet another exemplary embodiment of the present invention provides a brightness correcting target that is used for a 3D image restoring device that includes multiple cameras and an image processing device configured to correct brightnesses between images captured by the multiple cameras so as to be constantly maintained and generates a 3D image of an object using the multiple cameras, wherein the brightness correcting target is captured by the multiple cameras, becomes a reference in order to dispose the multiple cameras in predetermined positions, and is configured to have a size determined by considering a size of an object to be three-dimensionally restored.

Still another exemplary embodiment of the present invention provides an automatic brightness correcting method, including: acquiring images obtained by capturing an object with multiple cameras; and calculating an average value of brightness values of acquired images and correcting the brightnesses between the images captured by the multiple cameras based on the average brightness value of the total images calculated from the calculated average value so as to be constantly maintained.

The acquiring may include: communicating with the multiple cameras to receive the images captured by the multiple cameras; and storing the received images by mapping the images with the cameras that capture the images.

The correcting may include: calculating an average value, a maximum value, and a minimum value of the brightness values of the images captured by the multiple cameras and calculating an average brightness value of the total images from the calculated average value; selecting a field where the brightness value of the images are corrected based on an average value, a maximum value, and a minimum value of the brightness values of the images captured by the multiple cameras; and generating a correction function for correcting the brightness values of the images based on the average brightness value and the field to be corrected and converting the images using the generated correction function.

Still yet another exemplary embodiment of the present invention provides an automatic brightness correcting method, including: synchronizing multiple cameras to capture an object; calculating an average value, a maximum value, and a minimum value of brightness values of a field corresponding to the object from the images captured by the multiple cameras; calculating an average brightness value of the total images captured by the multiple cameras based on the calculated average brightness value; selecting a correction field for the field corresponding to the object based on the maximum value and the minimum value and the calculated average brightness value; generating a correction function of mapping the brightness value for every correction field selected with respect to the images captured by the multiple cameras with the average brightness value; and converting the images captured by the multiple cameras using the generated correction function.

According to exemplary embodiments of the present invention, it is possible to automatically obtain images having regular brightness between the images captured by multiple cameras.

According to exemplary embodiment of the present invention, it is also possible to automatically correct the irregularity of the brightness in the image and thus restore a precise 3D model using the images captured by multiple cameras whose brightness is finally corrected.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an arrangement of multiple cameras with respect to an object whose brightness will be corrected in order to correct a brightness of the object according to an exemplary embodiment of the present invention.

FIG. 2 is an exemplary diagram illustrating a brightness correcting target according to an exemplary embodiment of the present invention.

FIG. 3 is a block diagram illustrating an automatic brightness correcting device according to an exemplary embodiment of the present invention.

FIG. 4 is a block diagram illustrating a detailed configuration of an image processing unit according to an exemplary embodiment of the present invention.

FIG. 5 is a block diagram illustrating a detailed configuration of an image processing unit according to another exemplary embodiment of the present invention.

FIG. 6 is a brief flowchart illustrating an automatic brightness correcting method according to an exemplary embodiment.

FIG. 7 is a detailed flowchart illustrating an automatic brightness correcting method according to an exemplary embodiment.

FIG. 8 is a diagram illustrating a correction function for automatic brightness correction according to an exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

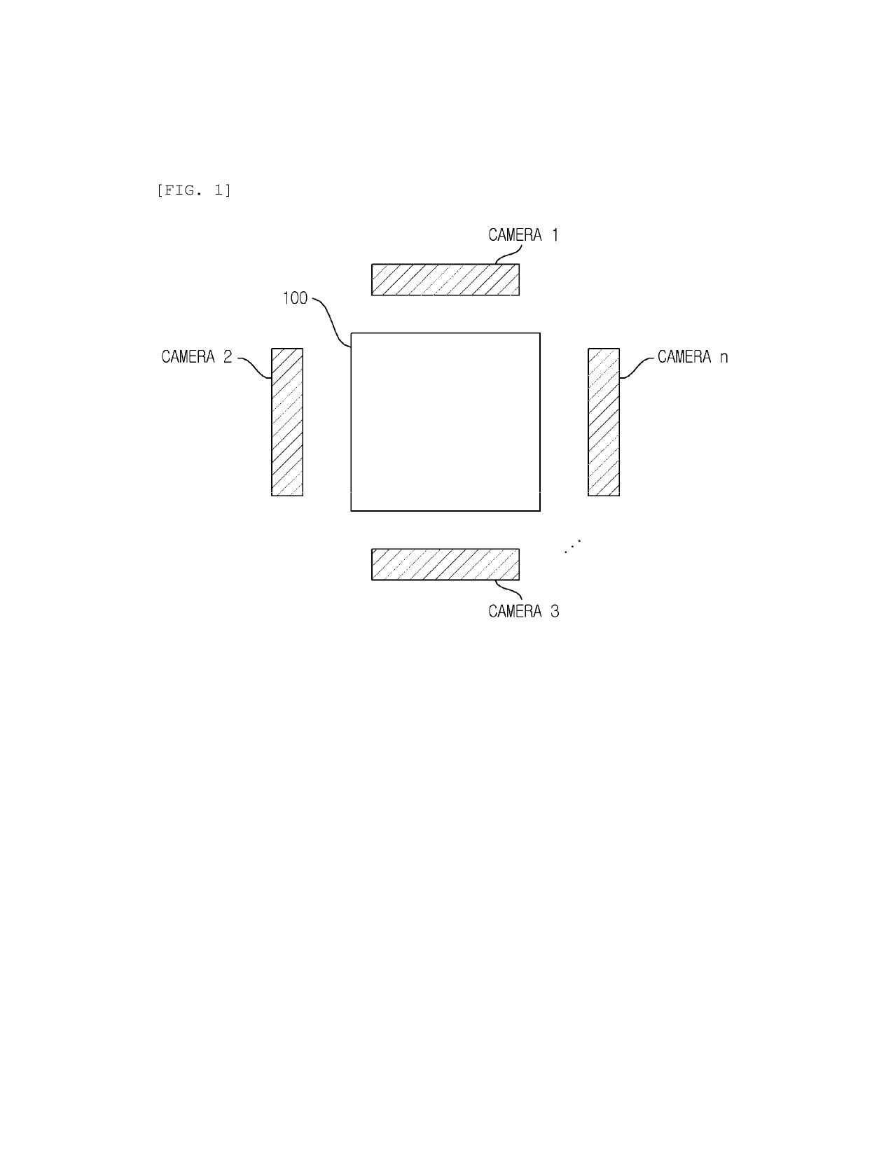

FIG. 1 is a diagram illustrating an arrangement of multiple cameras with respect to an object whose brightness will be corrected in order to correct a brightness of the object according to an exemplary embodiment of the present invention. Referring to FIG. 1, with respect to an object whose brightness will be corrected (hereinafter, referred to as brightness correcting target), cameras are arranged as many as sufficient for 3D restoration.

As shown in FIG. 1, n cameras are disposed so as to enclose the bright correcting target 100. However, the arrangement of the cameras for correcting a brightness is not limited thereto, but the arrangement of the cameras may be varied depending on a purpose of capturing the brightness correcting target for 3D restoration.

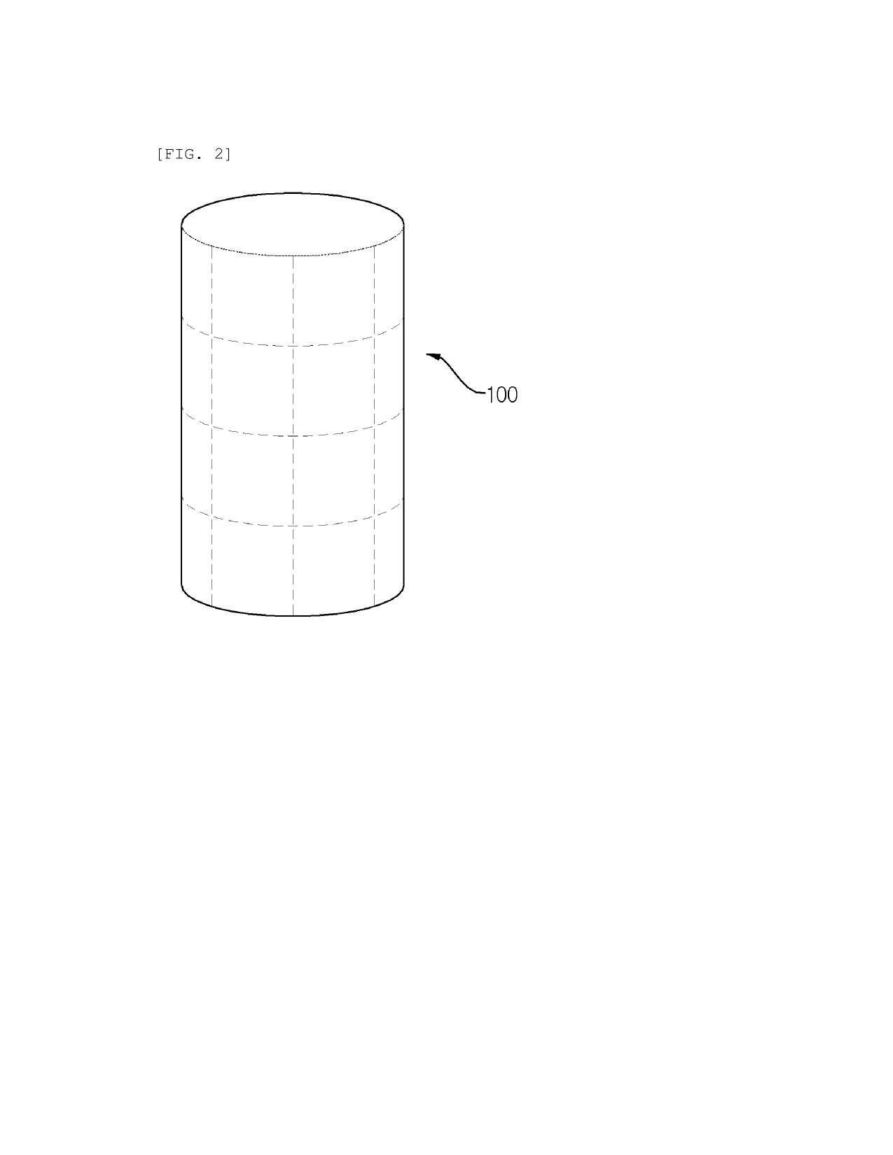

FIG. 2 is an exemplary diagram illustrating a brightness correcting target according to an exemplary embodiment of the present invention.

When an object is captured by multiple cameras in a studio environment, the subject is not uniformly illuminated due to a fixed illumination condition and an intensity of illumination is varied depending on the position, which causes the irregular brightness value of the captured image. Therefore, in order to solve the above problems, the exemplary embodiment of the present invention corrects a brightness using the brightness correcting target 100 as shown in FIG. 2.

The brightness correcting target 100 according to the exemplary embodiment of the present invention is configured to be cylindrical and the size is determined by considering the size of an object to be three-dimensionally restored.

A white cylindrical brightness correcting target 100 is also considered to obtain brightness distribution information of a capturing environment. In order to obtain an optimal image for brightness correction, the object may be manufactured using a non-reflective paint of bright gray color (R:200, G:200, B:200).

Even though it is described that the brightness correcting target 100 is cylindrical and white or bright gray, the shape and the color of the brightness correcting target are not limited thereto. If the shape is considered to solve the above-described problems, the shape is also included in the exemplary embodiment of the present invention.

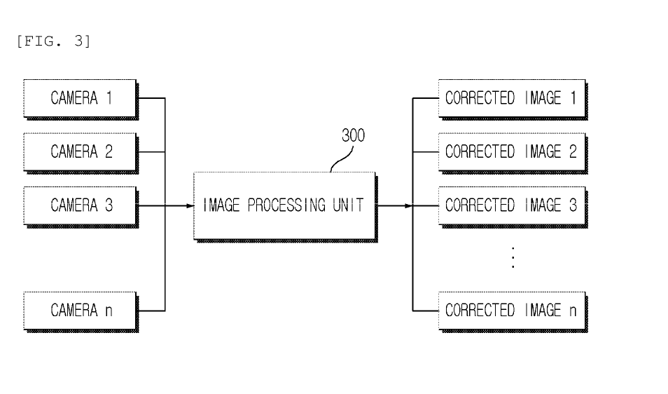

FIG. 3 is a block diagram illustrating an automatic brightness correcting device according to an exemplary embodiment of the present invention.

Referring to FIG. 3, the automatic brightness correcting device allows the image processing unit 300 to correct the brightness of images captured by multiple cameras 1, 2, 3, . . . , n and outputs the corrected image 1, 2, 3 . . . , n having corrected brightness.

The image processing unit 300 is a main component of the automatic brightness correcting device that corrects the brightness of the images captured by multiple cameras, and the specific function thereof will be described in detail below.

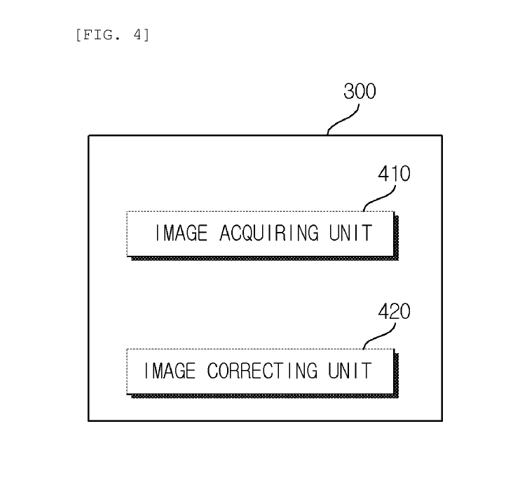

FIG. 4 is a block diagram illustrating a detailed configuration of an image processing unit according to an exemplary embodiment of the present invention. Referring to FIG. 4, the image processing unit 300 includes an image acquiring unit 410 and an image correcting unit 420.

The image acquiring unit 410 acquires images obtained by capturing an object, that is, a brightness correcting target with multiple cameras. The image acquiring unit 410 acquires an image having a brightness value which is varied depending on the position of the cameras and illumination condition.

The image acquiring unit 410 stores the images by mapping the images captured by the multiple cameras which are disposed in predetermined positions with respect to the object (brightness correcting target) with the cameras that capture the images. Here, the predetermined positions refer to positions where the brightness correcting target is captured in order to correct the brightness of the images captured by the multiple cameras or three-dimensionally restore the images.

The image acquiring unit 410 may includes a communicating unit that communicates with the multiple cameras to receive the images captured by the multiple cameras and a storing unit that stores the received images by mapping the received images with the cameras that capture the images.

The communicating unit communicates with the multiple cameras through at least one of a wired interface and a wireless interface to receive the captured images from the cameras.

The storing unit stores the images including specific identification codes of the multiple cameras. If the camera stores the image which is captured by that camera so as to contain a specific identification code for the camera, the image acquiring unit 410 automatically acquires information that maps the camera with the image captured by that camera.

Here, the specific identification code refers to identification information that indicates the camera and is implemented by various types such as metadata which is included in an image that is captured and stored by the camera.

The image correcting unit 420 corrects the brightness between the images captured by the multiple cameras based on an average brightness value calculated from the images captured by the multiple cameras so as to be constantly maintained.

The image correcting unit 420 calculates an average value of the brightness values of the images captured by the multiple cameras and corrects the brightness between the images captured by the multiple cameras based on the average brightness value of total image calculated from the calculated average value so as to be constantly maintained. The image correcting unit 420 selects a field where the brightness value of an image is corrected based on the average value, a maximum value, and a minimum value of the brightness value of the images captured by the multiple cameras.

The image correcting unit 420 generates a correction function for correcting the brightness value of the image based on the average brightness value and the region to be corrected and converts the image using the generated correction function.

The image correcting unit 420 corrects the brightness value in a predetermined region of the images captured by the multiple cameras using the average brightness value.

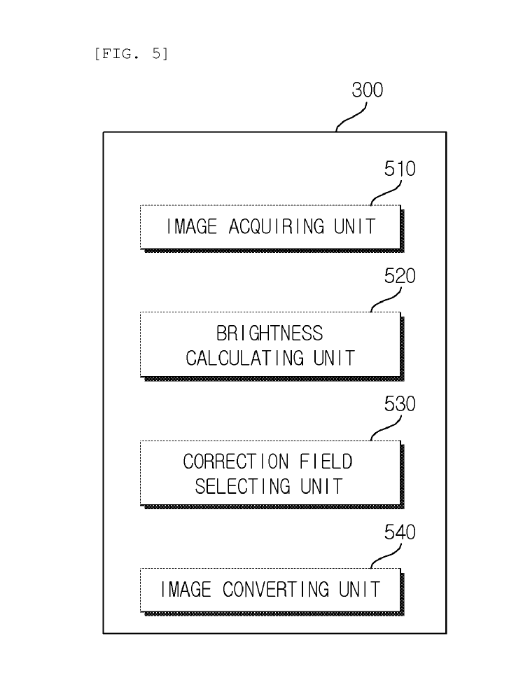

FIG. 5 is a block diagram illustrating a detailed configuration of an image processing unit according to another exemplary embodiment of the present invention. Referring to FIG. 5, the image processing unit 300 may include an image acquiring unit 510, a brightness calculating unit 520, a correction field selecting unit 530, and an image converting unit 540.

The image acquiring unit 510 receives images obtained by capturing an object, that is, the brightness correcting target by n cameras to function or serve as the image acquiring unit 410 shown in FIG. 4.

The brightness calculating unit 520 calculates an average value, a maximum value, and a minimum value of the brightness values of the images captured by the multiple cameras and calculates an average brightness value of total images from the calculated average value.

In other words, the brightness calculating unit 520 calculates the average value, the maximum value, and the minimum value of the brightness values of the brightness correcting target for every image captured by the n cameras and averages the calculated n average brightness values to determine a final average brightness value.

The correction field selecting unit 530 selects a field where the brightness value of the image is corrected based on the average value, the maximum value, and the minimum value of the brightness values of the images captured by the multiple cameras.

The image converting unit 540 generates a correction function for correcting a brightness value of an image based on the average brightness value and a field to be corrected and converts the image using the generated correction function.

Specifically, a correction function for correcting a brightness value of an image is generated using the average brightness value and the correction field that are determined in advance for n images and the image is converted using the generated correction function.

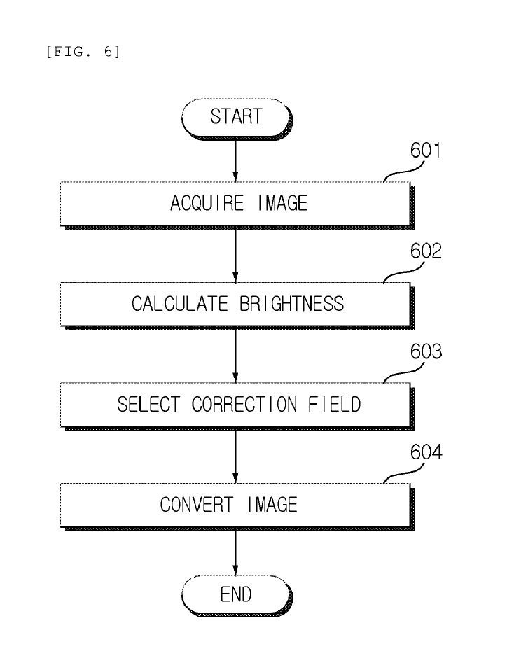

FIG. 6 is a brief flowchart illustrating an automatic brightness correcting method according to an exemplary embodiment.

First, an image obtained by capturing the object, that is, the brightness correcting target using multiple cameras is acquired (601).

In this case, step 601 includes receiving the images captured by the multiple cameras by communicating with the multiple cameras and storing the received images by mapping the images with the cameras that capture the images.

Next, the average value, the maximum value, and the minimum value of the images captured by the multiple cameras are calculated and the average brightness value of the total images is calculated from the calculated average value (602).

A correction field of the brightness value of the images is selected based on the average value, the maximum value, and the minimum value of the brightness values of the images captured by the multiple cameras (603).

Next, a correction function for correcting the brightness value of the image is generated based on the average brightness value and the correction field and the image is converted using the generated correction function to correct the brightnesses between the images captured by the multiple cameras to be constantly maintained (604).

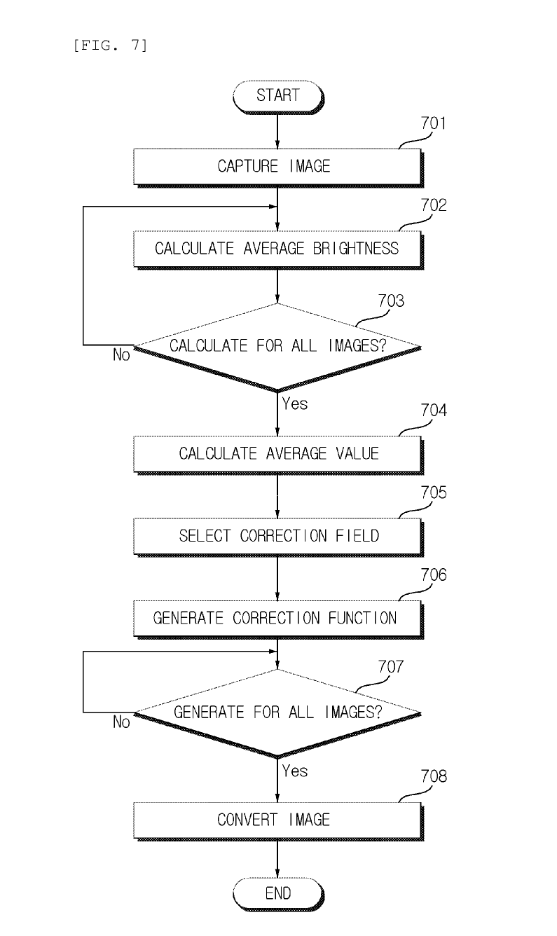

FIG. 7 is a detailed flowchart illustrating an automatic brightness correcting method according to an exemplary embodiment.

First, a brightness correcting target is provided in the center of a studio where a brightness is corrected and the multiple cameras disposed for 3D restoration are synchronized to capture the brightness correcting target (701).

An average brightness, a maximum brightness, and a minimum brightness of a field that corresponds to the brightness correcting target in an image captured by a first camera are calculated and then an average brightness, a maximum brightness, and a minimum brightness of a field that corresponds to the brightness correcting target from an image captured by a second camera are calculated.

By using the same method, a maximum brightness, and a minimum brightness of a field that corresponds to the brightness correcting target from images captured by n cameras are calculated (702).

When the brightness calculation is completed (703), an average of n average brightness values is calculated to calculate a final average brightness value (704).

An optimal correction field of the brightness correcting target is determined using a final average brightness value, a maximum value, and a minimum value (705). In this case, the brightness correction field basically includes three sections in a horizontal direction and five sections in a vertical direction. The section may be increased in order to increase the quality of the brightness correction result. In this case, the number of the sections in the horizontal and vertical directions may be odd so that the center value may be an average brightness.

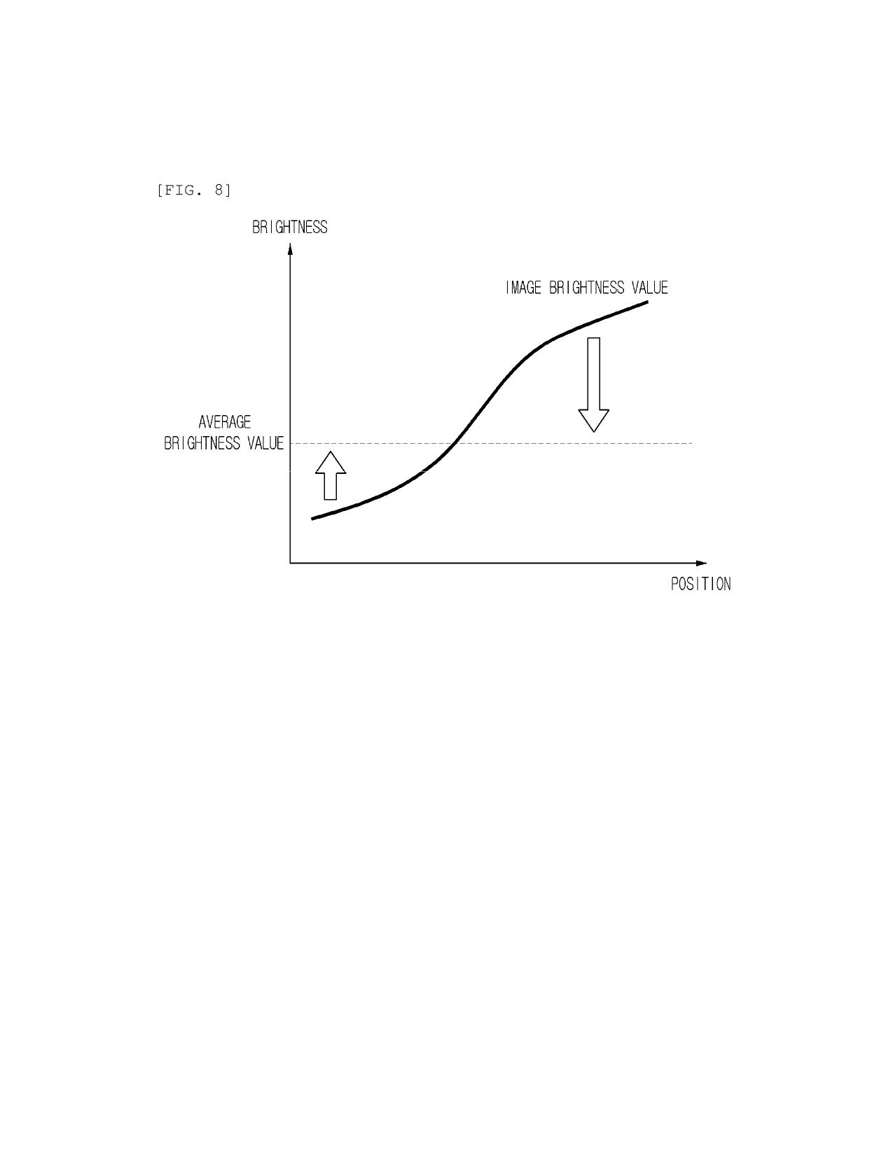

Next, if the correction field of the brightness correcting target for the image captured by the first camera is determined, the correction function that maps the brightness value for every correction field with the average brightness values as shown in FIG. 8 is generated.

FIG. 8 is a diagram illustrating a correction function for automatic brightness correction according to an exemplary embodiment.

Referring to FIG. 8, a function for every field that corrects the brightness value in a current section so as to be adjusted to the average brightness value is calculated.

An example of a specific calculating equation is as follows.

Correction value=brightness value in current section+|average brightness value−brightness value in current section|

The above-mentioned brightness correction may generate a correction function as a linear function in a vertical direction as shown in FIG. 8 or as a quadratic function that considers the vertical and horizontal directions.

Next, if the correction field of the brightness correcting target for the image captured by the second camera is determined, the correction function that maps the brightness value for every correction field with the average brightness values is generated as shown in FIG. 8 as follows.

If the correction section of the brightness correcting target for the images captured by n cameras that are disposed in the studio is determined by the same method, the correction function that maps the brightness value for every correction field with the average brightness values is generated as shown in FIG. 8 (706).

Finally, if the generation of the correction function is completed (707), the captured image is converted using the brightness correction function generated by n cameras to obtain a finally converted image in which the brightnesses of the images captured by the multiple cameras match (708).

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An automatic brightness correcting device, comprising:
an image acquiring unit configured to acquire images obtained by capturing an object with multiple cameras; and
an image correcting unit configured to correct brightnesses between images captured by the multiple cameras based on an average brightness value calculated from the images captured by the multiple cameras so as to be constantly maintained.

2. The automatic brightness correcting device of claim 1, wherein the image acquiring unit acquires images whose brightness values are varied depending on a position of a camera and an illumination condition.

3. The automatic brightness correcting device of claim 1, wherein the image acquiring unit stores the images captured by the multiple cameras that are disposed in a predetermined position with respect to the object so as to be mapped with the cameras that capture the images.

4. The automatic brightness correcting device of claim 1, wherein the image acquiring unit includes:
a communicating unit configured to communicate with the multiple cameras to receive the images captured by the multiple cameras; and
a storing unit configured to store the received image so as to be mapped with the cameras that capture the images.

5. The automatic brightness correcting device of claim 4, wherein the communicating unit communicates with the multiple cameras through at least one of a wired interface and a wireless interface.

6. The automatic brightness correcting device of claim 4, wherein the storing unit stores images including specific identification codes of the multiple cameras.

7. The automatic brightness correcting device of claim 1, wherein the image correcting unit calculates an average value of brightness values of the images captured by the multiple cameras and corrects the brightnesses between the images captured by the multiple cameras based on an average brightness value of the total images calculated from the calculated average value so as to be constantly maintained.

8. The automatic brightness correcting device of claim 1, wherein the image correcting unit selects a field where the brightness value of the image is corrected based on an average value, a maximum value, and a minimum value of the brightness values of the images captured by the multiple cameras.

9. The automatic brightness correcting device of claim 8, wherein the image correcting unit generates a correction function for correcting the brightness value of the images based on the average brightness value and the field to be corrected and converts the images using the generated correction function.

10. The automatic brightness correcting device of claim 1, wherein the image correcting unit corrects the brightness value in a predetermined field of each of the images captured by the multiple cameras using the average brightness value.

11. The automatic brightness correcting device of claim 1, wherein the image correcting unit includes:
a brightness calculating unit configured to calculate an average value, a maximum value, and a minimum value of the brightness values of the images captured by the multiple cameras and calculate the average brightness value of the total images from the calculated average value;
a correction field selecting unit configured to select a field where the brightness values of the images are corrected based on the average value, the maximum value, and the minimum value of the brightness values of the images captured by the multiple cameras; and
an image converting unit configured to generate the correction function for correcting the brightness value of the images based on the average brightness value and the field to be corrected and convert the image using the generated correction function.

12. An automatic brightness correcting device, comprising:
a brightness correcting target configured to be cylindrical and to have a size determined by considering a size of an object to be three-dimensionally restored;
multiple cameras that are disposed in predetermined positions with respect to a brightness correcting target and capture the brightness correcting target; and
an image processing device configured to correct the brightnesses between the images captured by the multiple cameras based on the average brightness value calculated from the images captured by the multiple cameras so as to be constantly maintained.

13. The automatic brightness correcting device of claim 12, wherein the brightness correcting target has a predetermined color so as to obtain an optimal image for brightness correction.

14. The automatic brightness correcting device of claim 13, wherein the brightness correcting target is manufactured by non-reflective inks.

15. The automatic brightness correcting device of claim 12, wherein the image processing device generates a 3D image using the corrected image.

16. An automatic brightness correcting method, comprising:
acquiring images obtained by capturing an object with multiple cameras; and
calculating an average value of brightness values of acquired images and correcting the brightnesses between the images captured by the multiple cameras based on the average brightness value of the total images calculated from the calculated average value so as to be constantly maintained.

17. The automatic brightness correcting method of claim 16, wherein the acquiring includes:
communicating with the multiple cameras to receive the images captured by the multiple cameras; and
storing the received images by mapping the images with the cameras that capture the images.

18. The automatic brightness correcting method of claim 16, wherein the correcting includes:
calculating an average value, a maximum value, and a minimum value of the brightness values of the images captured by the multiple cameras and calculating an average brightness value of the total images from the calculated average value;
selecting a field where the brightness value of the images are corrected based on an average value, a maximum value, and a minimum value of the brightness values of the images captured by the multiple cameras; and
generating a correction function for correcting the brightness values of the images based on the average brightness value and the field to be corrected and converting the images using the generated correction function.
